(19) United States
(12) Patent Application Publication
(10) Pub. No.: US 2006/0052075 A1
(43) Pub. Date: Mar. 9, 2006

(54) Testing integrated circuits using high bandwidth wireless technology

(76) Inventors: Rajeshwar Galivanche, Saratoga, CA (US); Tak M. Mak, Union City, CA (US); Sandip Kundu, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/936,090

(22) Filed: Sep. 7, 2004

(51) Int. Cl. H04B 1/26

(52) U.S. Cl. 455/323

(57) ABSTRACT

According to embodiments of the present invention, a UWB (ultra wideband) communication system is employed to wirelessly test and configure circuits on a die. Baseband signals may be utilized with resulting simplification in CMOS circuits, or orthogonal frequency division multiplexing may be employed to allow more than one communication channel. In one embodiment, the antenna for communicating with circuits on a die is placed between the package and the heat spreader, in electrical contact with a solder bump. In another embodiment, the antennas are placed onto wafer scribe lines, and are used to test chips before the wafer is sawed. Other embodiments are described and claimed.

### FIELD

Embodiments of the present invention pertain to wireless circuits, and more particularly, to a wireless communication system for testing and configuring circuits on a die.

### BACKGROUND

To test an integrated circuit on a die, it is desirable to have good controllability so as to be able to set various internal nodes to desired logical states, and to have good observability so that appropriate nodes may be observed to determine if the integrated circuit is performing correctly. Usually, controllability and observability are achieved by modifying existing circuit state elements such as latches and flip-flops, and configuring them to form a shift register in a test mode. In some instances, additional state elements are introduced to observe the circuit state, where such state elements are often connected to each other to form a shift register, commonly referred to as a scan chain.

The input and output ports of a scan chain, commonly called test access pins, are connected to the input and output ports of the die under test. The test access pins are often multiplexed with other functional pins of the die. In certain situations, the scan chain may be configured to form a linear feedback shift register (LFSR) so that the response of a circuit under test to multiple stimulus cycles may be stored in the form of a signature. The signature is periodically flushed out to determine the correctness of the circuit behavior. While the use of a scan chain reduces the amount of data to be flushed out, it may also lead to a loss of resolution in diagnosing faulty circuit behavior.

Data captured in the chain scan is observed at the die input and output ports by serially shifting the scan chain (or the LFSR). However, such testing is difficult if the die under test is mounted onto a board or a system where direct access to the test access pins is not practical. Furthermore, based on the number of scan nodes in the circuit under test, multiple scan chains are created to reduce the time to set and observe the scan nodes, which may require multiple test access ports. The need to route the scan chains test access spins to the die periphery may lead to a significant amount of metal interconnect.

An approach suggested to overcome some of the limitation discussed above, limited to circuit testing before wafer sawing, is to make use of a wireless coupling between a circuit under test and the test equipment, where antennas and radio frequency (RF) transceivers are formed on the scribe lines of the wafer and the transceivers are coupled to the integrated circuits. However, such an approach does not lend to testing circuits on an individual die after the wafer has been sawed. Furthermore, direct electrical connection between the RF transceivers and circuits under test may leave exposed wires after wafer sawing, perhaps reducing reliability. In addition, the RF transceivers proposed utilize typical architectures employing modulation and demodulation, whereby signals are up-converted for transmission and down converted to IF frequencies. Such typical transceiver architectures may not be easily implemented in a CMOS (Complementary Metal Oxide Semiconductor) process.

### BRIEF DESCRIPTION OF THE DRAWINGS

FIG. 1 illustrates an architecture for UWB communication between a die and test equipment according to an embodiment of the present invention.

FIG. 2 illustrates a UWB transceiver architecture.

FIGS. 3a and 3b illustrate another UWB transceiver architecture.

FIG. 4 illustrates an antenna on a package for a UWB system according to an embodiment of the present invention.

FIG. 5 illustrates antennas on a wafer for a UWB system according to an embodiment of the present invention.

FIG. 6 illustrates inductive coupling between an antenna on a wafer and a die under test according to an embodiment of the present invention.

FIG. 7 illustrates embodiments in which an antenna is formed on a circuit board or formed on a probe card.

### DESCRIPTION OF EMBODIMENTS

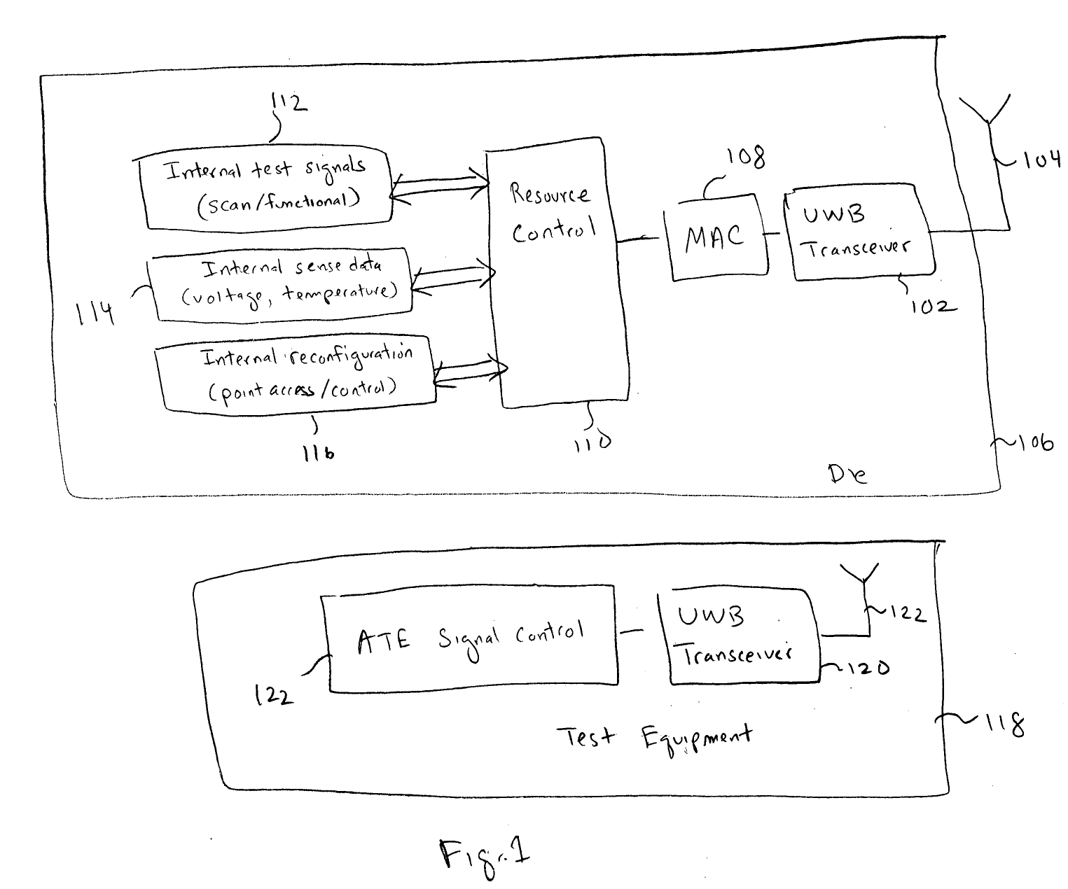

FIG. 1 provides a system level view of an embodiment of the present invention for testing an integrated circuit by use of a wireless system. In FIG. 1, ultra wide bandwidth (UWB) transceiver 102 and antenna 104 reside on die 106. Also residing on die 106 are MAC (media access control) functional unit 108 and resource control functional unit 110. Functional units 112, 114, and 116 exchange data with resource control 110. Functional unit 112 represents internal test signals that are observed and sent to resource control 110, and also represents test signals that are received from resource control 110 and applied to internal nodes. Functional unit 112 represents sense data, such as core voltage and temperature, that are provided to resource control 110. Functional unit 116 represents data provided to resource control 110 indicating how a configurable circuit on the die is configured, and also represents data received from resource control 110 that is to be applied to the configurable circuit to place it in a desired configuration.

Data provided to resource control 110 may be transmitted by UWB transceiver 102 to test equipment 118, and data provided by test equipment 118 may be provided to the appropriate functional units 112 and 116 via UWB transceiver 102, MAC 108 and resource control 110. Components on test equipment 118 include UWB transceiver 120, antenna 122, and ATE (Automatic Test Equipment) signal control functional unit 122. ATE signal control may perform encryption and decryption of data that is transmitted or received by UWB transceiver 120.

The components shown in FIG. 1 essentially make up a communication system, which may be a packet-based communication system. When data is to be transmitted from die 106 to test equipment 118, resource control 110 may partition data from functional units 112, 114, or 116 into data packets with a header to identify which functional unit provided the data. MAC 108 may add an additional header for framing and other types of control, such as error correction or encryption. When control information is to be transmitted from test equipment 118 to die 106, ATE signal control 122 adds the appropriate header so that the transmitted control information is provided to the desired functional unit on die 106.

Traditionally, a UWB transmitter transmits a baseband signal where the frequency content of the transmitted signal includes frequencies from zero to some value representative of the bandwidth of the signal, where the bandwidth if about 500 MHz or greater. In practice, the signal may be a pulse in the time domain. However, more recently, the definition of UWB has been broadened so that UWB transmitters now may employ orthogonal frequency division multiplexing, whereby more than one channel is utilized where each channel occupies non-overlapping portion of the frequency spectrum. In this case, except for the baseband channel, a baseband signal is up-converted to a bandlimited signal centered about a center frequency, where the signal bandwidth is about or greater than 20% of its center frequency.

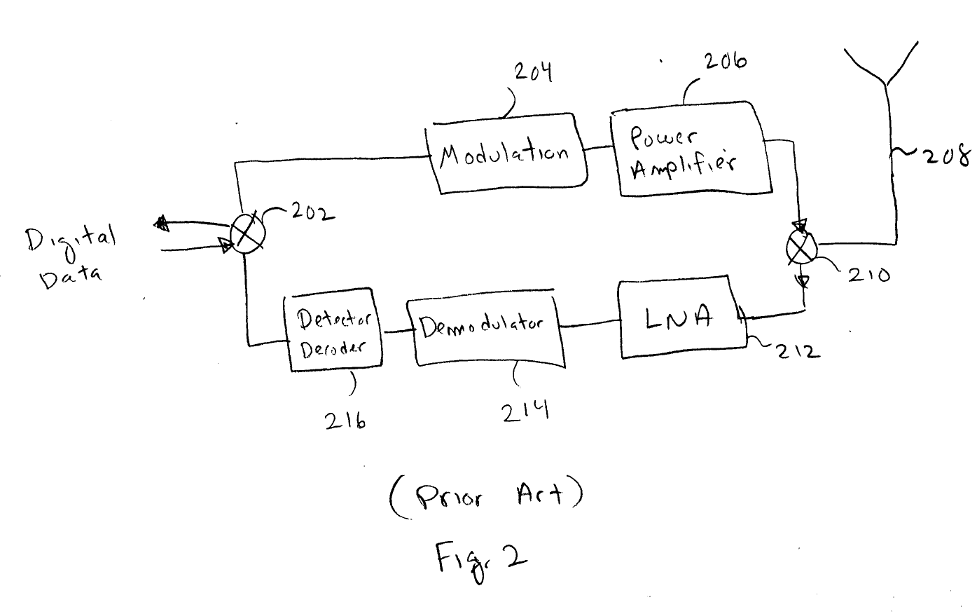

An example of a UWB transceiver may be illustrated as shown in FIG. 2. Data that is to be transmitted is provided via switch 202 to modulation functional unit 204, whereby a signal is amplified by power amplifier 206 and switched to antenna 208 via switch 210. When data or control information is to be received, switch 210 is set so that antenna 208 is coupled to LNA (Low Noise Amplifier) 212 for amplification, followed by demodulation by demodulator functional unit 214, and detection and decoding by detector/decoder functional unit 216. Detector/decoder functional unit 216 also may perform bit and frame synchronization. The data packets, with appropriate headers, are provided to other functional units via switch 202.

The architecture of FIG. 2 may be appropriate to UWB systems employing orthogonal FDM, where modulation functional unit 204 includes the function of up-converting a baseband signal to a bandpass signal with non-zero carrier frequency. Although the term “switch” has been used for functional unit 210, in practice this functional unit may be a waveguide network so that a RF (Radio Frequency) signal is guided from power amplifier 206 to antenna 208, and a RF signal received by antenna 208 is guided to LNA 212. For orthogonal FDM, the receiver portion of the transceiver of FIG. 2 may be tuned to a carrier frequency different than that used by the transmitter portion of the transceiver so that a full duplex mode may be implemented.

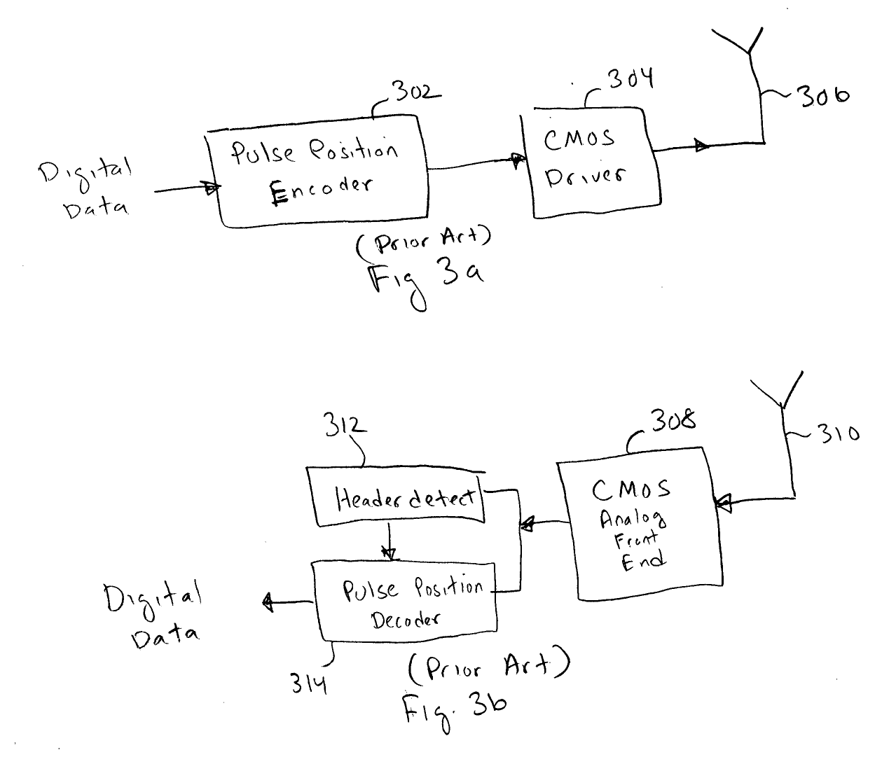

The architecture of FIG. 2 may also be appropriate to traditional UWB systems in which only baseband signals are employed. For example, for such systems, modulation functional unit 204 may be a pulse position coder, whereby a pulse within a specified frame interval is transmitted in which the position of the pulse relative to the frame encodes the digital information. Such an architecture is made more explicit in FIGS. 3a and 3b, showing a transmitter and receiver, respectively. The transmitter in FIG. 3a shows pulse position coder 302 providing a pulse to CMOS (Complementary Metal Oxide Semiconductor) driver 304. CMOS driver 304 may be realized by a CMOS inverter, and is coupled directly to transmit antenna 306. The receiver in FIG. 3b shows CMOS AFE (Analog Front End) 308 coupled directly to receive antenna 310. CMOS AFE 308 may be realized by a CMOS comparator. Header detect functional unit 312 and pulse position decoder 314 provide digital data packets and headers to other functional units.

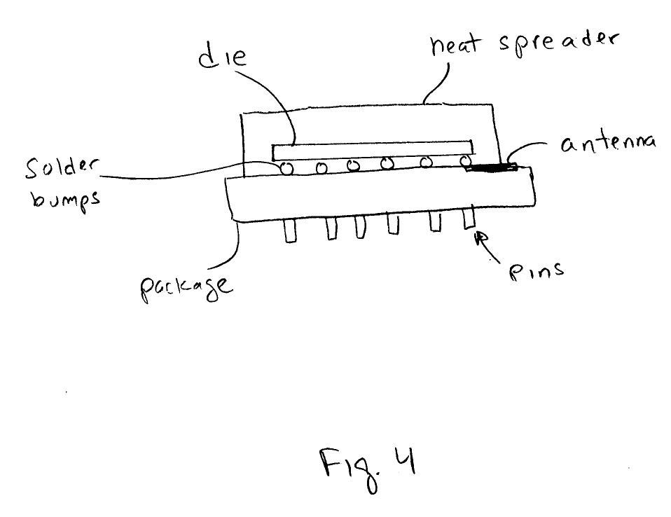

Antenna placement may be placed on the die package, and connected to the die via a solder bump. This arrangement is illustrated in FIG. 4, which shows a cross-sectional view of a die mounted on a package via solder bumps. The components in FIG. 4 are indicated in FIG. 4, which shows that the antenna is in between the heat spreader and the package. The heat spreader is usually grounded, so the antenna should be positioned so that a portion of the antenna is outside the heat spreader. For testing chip-to-chip communication, an antenna may be placed on a circuit board coupled to one or more chips, or connected to a bus.

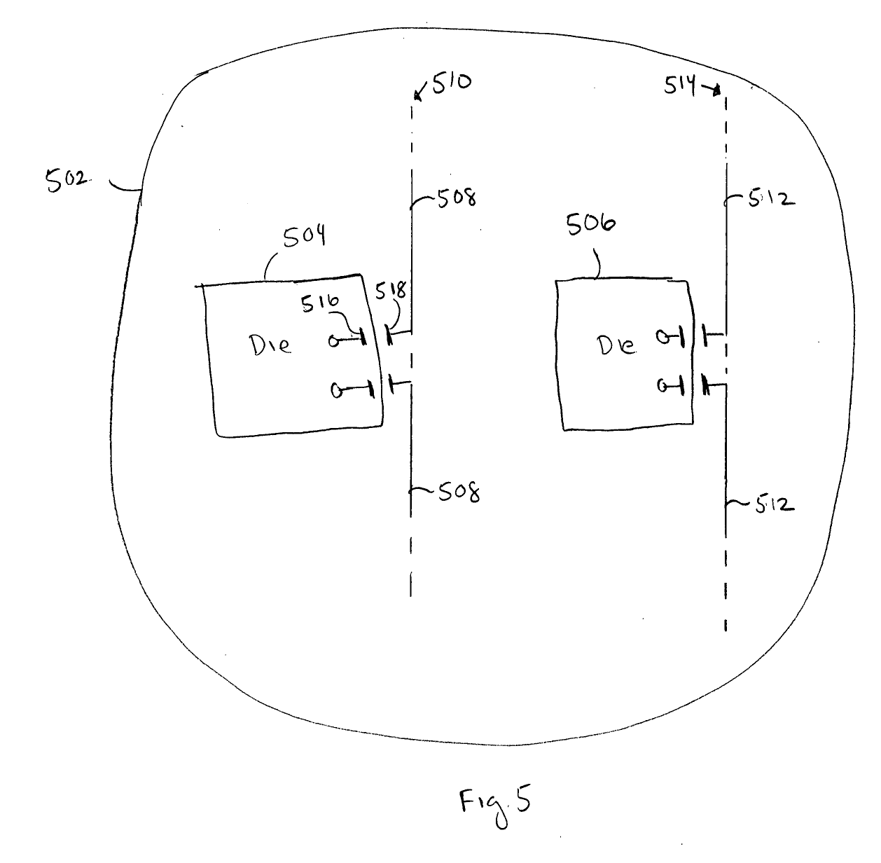

For sorting and testing, it may be advantages to test each of the die on a wafer before the wafer is cut. FIG. 5 shows an embodiment for sorting and testing before the wafer is sawed, where for simplicity only a portion of a wafer (502) is shown with two dice, die 504 and die 506. In the example of FIG. 5, a dipole antenna is coupled to each die, where each antenna is formed on a scribe line. For example, dipole antenna 508 is formed onto scribe line 510, and dipole antenna 512 is formed onto scribe line 514. Capacitive coupling between a die and its respective antenna is realized by forming one plate of a capacitor on the die and the other plate of the capacitor on the antenna. For example, capacitor plate 516 is formed on die 504 and capacitor plate 518 is formed on wafer 502 nearby plate 516, where plate 518 is connected to one-half of dipole antenna 508 as shown. Capacitor plates 516 and 518 form the two plates of a capacitor. Capacitive coupling allows for no exposed metal, other than connections for the pins, after the wafer is sawed.

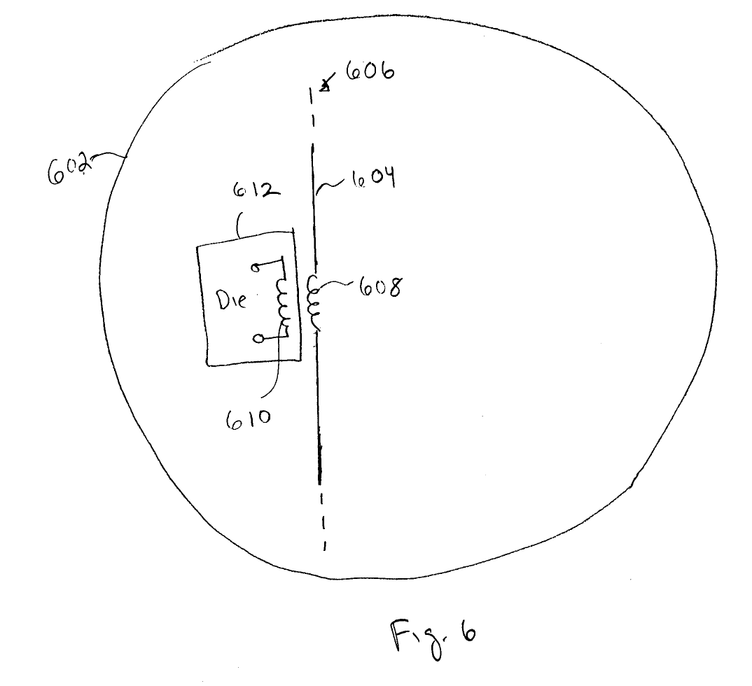

Inductive coupling may also be employed. For example, in FIG. 6, wafer 602 is shown in which antenna 604 is formed on scribe line 606. First winding 608 and second winding 610 form an inductor for coupling antenna 604 to die 612.

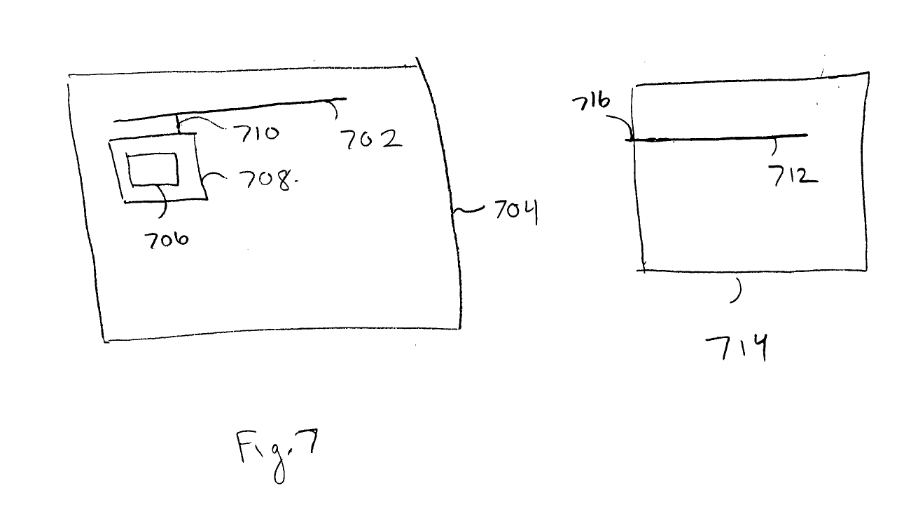

An antenna for a die under test may be formed on a circuit board to which the die is attached. For example, a simple plan view of such an embodiment is illustrated in FIG. 7, where antenna 702 is formed on circuit board 704. A circuit on die 706 connects to antenna 702 via a pin on package 708 and interconnect 710. Alternatively, an antenna 712 may be formed on probe card 714, where pin 716 on probe card 714 is placed in contact with a pin on package 708, where now antenna 712 serves as the antenna for communicating with a tester.

Various modifications may be made to the disclosed embodiments without departing from the scope of the invention as claimed below. Furthermore, it is to be understood in these letters patent that the meaning of “A is connected to B”, where A or B may be, for example, a node or device terminal, is that A and B are connected to each other so that the voltage potentials of A and B are substantially equal to each other. For example, A and B may be connected by way of an interconnect, transmission line, etc. In integrated circuit technology, the “interconnect” may be exceedingly short, comparable to the device dimension itself. For example, the gates of two transistors may be connected to each other by polysilicon or copper interconnect that is comparable to the gate length of the transistors. As another example, A and B may be connected to each other by a switch, such as a transmission gate, so that their respective voltage potentials are substantially equal to each other when the switch is ON.

It is also to be understood that the meaning of “A is coupled to B” is that either A and B are connected to each other as described above, or that, although A and B may not be connected to each other as described above, there is nevertheless a device or circuit that is connected to both A and B. This device or circuit may include active or passive circuit elements. For example, A may be connected to a circuit element which in turn is connected to B.

It is also to be understood in these letters patent that a “current source” may mean either a current source or a current sink. Similar remarks apply to similar phrases, such as, “to source current”.

It is also to be understood that various circuit blocks, such as current mirrors, amplifiers, etc., may include switches so as to be switched in or out of a larger circuit, and yet such circuit blocks may still be considered connected to the larger circuit because the various switches may be considered as included in the circuit block.

It is also to be understood that a claimed equality or match is interpreted to mean an equality or match within the tolerances of the process technology.

What is claimed is:

1. A system comprising:
a wafer comprising a plurality of integrated circuits, wherein each integrated circuit comprises an ultra wide bandwidth (UWB) transceiver; and
a tester comprising an UWB transceiver to communication with the ultra wide bandwidth transceivers on the wafer.

2. The system as set forth in claim 1, the wafer have scribe lines, the wafer further comprising at least one antenna, where each of the least one antenna is formed on one of the scribe lines.

3. The system as set forth in claim 2, the wafer further comprising at least one capacitor so that each of the at least one antenna is capacitively coupled to at least one of the UWB transceivers on the wafer.

4. The system as set forth in claim 2, the wafer further comprising at least one inductor so that each of the at least one antenna is inductively coupled to at least one of the UWB transceivers on the wafer.

5. The system as set forth in claim 1, wherein the UWB transceivers transmit baseband signals.

6. The system as set forth in claim 5, the wafer have scribe lines, the wafer further comprising at least one antenna, where each of the least one antenna is formed on one of the scribe lines.

7. The system as set forth in claim 6, the wafer further comprising at least one capacitor so that each of the at least one antenna is capacitively coupled to at least one of the UWB transceivers on the wafer.

8. The system as set forth in claim 6, the wafer further comprising at least one inductor so that each of the at least one antenna is inductively coupled to at least one of the UWB transceivers on the wafer.

9. The system as set forth in claim 1, wherein the UWB transceivers transmit signals having a carrier frequency, wherein each transmitted signal has a bandwidth at least twenty percent that of its carrier frequency.

10. The system as set forth in claim 9, the wafer have scribe lines, the wafer further comprising at least one antenna, where each of the least one antenna is formed on one of the scribe lines.

11. The system as set forth in claim 10, the wafer further comprising at least one capacitor so that each of the at least one antenna is capacitively coupled to at least one of the UWB transceivers on the wafer.

12. The system as set forth in claim 10, the wafer further comprising at least one inductor so that each of the at least one antenna is inductively coupled to at least one of the UWB transceivers on the wafer.

13. A wafer comprising:
a plurality of scribe lines;
a plurality of antennas, where each of the antennas is formed on one of the scribe lines;
a plurality of capacitors, each capacitor comprising a first plate connected to one of the antennas, and a second plate not connected to the first plate; and
a plurality of transceivers, where each transceiver is connected to one of the second plates.

14. The wafer as set forth in claim 13, wherein each of the transceivers is an ultra wide bandwidth (UWB) transceiver.

15. The wafer as set forth in claim 14, wherein each of the transceivers transmits a baseband signal.

16. The wafer as set forth in claim 14, wherein each of the transceivers transmits a signal having a bandwidth and a carrier frequency, where for each signal its bandwidth is at least twenty percent that of its carrier frequency.

17. A system comprising:
a tester comprising a transceiver; and
a wafer comprising:
a plurality of scribe lines;
a plurality of antennas, where each of the antennas is formed on one of the scribe lines;
a plurality of capacitors, each capacitor comprising a first plate connected to one of the antennas, and a second plate not connected to the first plate; and
a plurality of transceivers to communicate with the transceiver on the tester, where each transceiver on the wafer is connected to one of the second plates.

18. The system as set forth in claim 17, wherein each of the transceivers is a ultra wide bandwidth (UWB) transceiver.

19. The system as set forth in claim 18, wherein each of the transceivers transmits a baseband signal.

20. The system as set forth in claim 18, wherein each of the transceivers transmits a signal having a bandwidth and a carrier frequency, where for each signal its bandwidth is at least twenty percent that of its carrier frequency.

21. A wafer comprising:
a plurality of scribe lines;
a plurality of antennas, where each of the antennas is formed on one of the scribe lines;
a plurality of inductors, each inductor comprising a first winding connected to one of the antennas, and a second winding not connected to the first winding; and
a plurality of transceivers, where each transceiver is connected to one of the second windings.

22. The wafer as set forth in claim 21, wherein each of the transceivers is an ultra wide bandwidth (UWB) transceiver.

23. The wafer as set forth in claim 22, wherein each of the transceivers transmits a baseband signal.

24. The wafer as set forth in claim 22, wherein each of the transceivers transmits a signal having a bandwidth and a carrier frequency, where for each signal its bandwidth is at least twenty percent that of its carrier frequency.

25. A system comprising:
a tester comprising a transceiver; and
a wafer comprising:
a plurality of scribe lines;
a plurality of antennas, where each of the antennas is formed on one of the scribe lines;
a plurality of inductors, each capacitor comprising a first winding connected to one of the antennas, and a second winding not connected to the first plate; and
a plurality of transceivers to communicate with the transceiver on the tester, where each transceiver on the wafer is connected to one of the second windings.

26. The system as set forth in claim 25, wherein each of the transceivers is a ultra wide bandwidth (UWB) transceiver.

27. The system as set forth in claim 26, wherein each of the transceivers transmits a baseband signal.

28. The system as set forth in claim 26, wherein each of the transceivers transmits a signal having a bandwidth and a carrier frequency, where for each signal its bandwidth is at least twenty percent that of its carrier frequency.

29. An apparatus comprising:
a die;
a set of solder bumps in electrical contact with the die;
a package in contact with the set of solder bumps;
a heat spreader adjacent to the die; and
an antenna disposed on the package.

30. The apparatus as set forth in claim 29, wherein a first portion of the antenna is in between the heat spreader and the package, and a second portion is disposed on the package but outside the heat spreader.

31. The apparatus as set forth in claim 30, further comprising an ultra wide bandwidth (UWB) transceiver coupled to the antenna.

32. The apparatus as set forth in claim 31, wherein the transceiver transmits a baseband signal.

33. The apparatus as set forth in claim 31, wherein the transceiver transmits a signal having a carrier frequency and a bandwidth at least twenty percent the carrier frequency.

34. The apparatus as set forth in claim 29, further comprising an ultra wide bandwidth (UWB) transceiver coupled to the antenna.

36. The apparatus as set forth in claim 34, wherein the transceiver transmits a baseband signal.

37. The apparatus as set forth in claim 34, wherein the transceiver transmits a signal having a carrier frequency and a bandwidth at least twenty percent the carrier frequency.

38. A system comprising:
a die comprising a UWB transceiver;
a board comprising an antenna, wherein the antenna is in electrical communication with the die; and
a tester comprising a UWB transceiver to communicate with the UWB transceiver of the die to test the die.

39. A system comprising:
a die comprising a UWB transceiver and a pin; and
a probe board, wherein the die is not in contact with the probe board, the probe board comprising an antenna and a pin to make electrical contact with the pin on the die.
